(19) United States
(12) Patent Application Publication
(10) Pub. No.: US 2025/0369873 A1
(43) Pub. Date: Dec. 4, 2025

(54) INSPECTION SYSTEM, INSPECTION METHOD, MODEL GENERATION SYSTEM, DETERMINATION SYSTEM, MODEL GENERATION METHOD, AND PROGRAM

(71) Applicant: Panasonic Intellectual Property Management Co., Ltd., Osaka (JP)

(72) Inventors: Takahiro KATO, Osaka (JP); Yoko KAWAGUCHI, Kyoto (JP); Hisashi AIKAWA, Osaka (JP)

(21) Appl. No.: 18/571,004

(22) PCT Filed: Mar. 30, 2022
(86) PCT No.: PCT/JP2022/016280

§ 371 Date: Jan. 16, 2025

(30) Foreign Application Priority Data
Jun. 18, 2021 (JP) 2021-101896

(51) Int. Cl. G01N 21/29; G01N 21/17

(52) U.S. Cl. CPC G01N 21/29; G01N 2021/1751; G01N 2021/1765; G01N 2201/121

(57) ABSTRACT

An inspection system includes an inspection image acquirer, a spectrum corrector, a spectrum determiner, and a result output. The inspection image acquirer is configured to acquire an inspection target image. The inspection target image is obtained by imaging an object including an inspection target and a background in four or more wavelength ranges. The spectrum corrector is configured to make a correction based on a spectrum of an image of the background to a first spectrum to generate a second spectrum. The first spectrum is a spectrum of an image of the inspection target in the inspection target image. The spectrum determiner is configured to determine, based on the second spectrum, whether or not the inspection target is a first substance.

### TECHNICAL FIELD

The present disclosure relates to inspection systems, inspection methods, model generation systems, determination systems, model generation methods, and programs and specifically relates to an inspection system, an inspection method, a model generation system, a determination system, a model generation method, and a program which use an image including pieces of data in four or more wavelength ranges.

### BACKGROUND ART

As a method for visually distinguishing substances difficult to be distinguished from each other by ordinary color images with RGB which are three primary colors and/or by the bare eye, a method using an image including pieces of data in many wavelength ranges is used (see, for example, Patent Literature 1). An ordinary color image includes pieces of data in respective wavelength ranges corresponding to R, G, and B. That is, the ordinary color image includes pieces of data in three wavelength ranges. In contrast, a so-called multispectral image and a so-called hyperspectral image each include pieces of data in four or more wavelength ranges. The multispectral image and the hyperspectral image each include pieces of data in four or more wavelength ranges in the wavelength range of a visible light region, the wavelength range in an ultraviolet region, and an infrared region. For example, a hyperspectral image disclosed in Patent Literature 1 includes pieces of data in a plurality of wavelength ranges.

The method for distinguishing substances from each other by using an image including pieces of data in many wavelength ranges in a conventional system described in Patent Literature 1 includes identifying the substances assuming that a reflection spectrum of an object is the same as a spectrum of each of pixels included in an image of the object in image data. The object includes an inspection target and a background. However, in an inspection target image taken of the inspection target and the background which constitute the object, the image of the inspection target and the image of the background are in some cases not satisfactorily separate from each other. That is, a reflection spectrum of the background may be mixed with a spectrum of each of pixels included in the image of the inspection target. This may make a difference between the spectrum of each of the pixels included in the image of the inspection target and an intrinsic spectrum of the substance of the inspection target, which may reduce the accuracy of identification of the substance of the inspection target.

### CITATION LIST

### Patent Literature

Patent Literature 1: JP 2010-256303 A

### SUMMARY OF INVENTION

In view of the foregoing, an object of the present disclosure is to improve the accuracy of identification of a substance of an inspection target in an inspection system, an inspection method, a model generation system, a determination system, a model generation method, and a program which use an inspection target image taken of the inspection target and a background.

An inspection system according to an aspect of the present disclosure includes an inspection image acquirer, a spectrum corrector, a spectrum determiner, and a result output. The inspection image acquirer is configured to acquire an inspection target image. The inspection target image is obtained by imaging an object including an inspection target and a background in four or more wavelength ranges. The spectrum corrector is configured to make a correction based on a spectrum of an image of the background to a first spectrum to generate a second spectrum. The first spectrum is a spectrum of an image of the inspection target in the inspection target image. The spectrum determiner is configured to determine, based on the second spectrum, whether or not the inspection target is a first substance. The result output is configured to output a determination result by the spectrum determiner.

A model generation system according to an aspect of the present disclosure includes a reference image acquirer and a correction model generator. The reference image acquirer is configured to acquire a first reference image and a second reference image. Each of the first reference image and the second reference image is obtained by imaging a predetermined substance at least one of a dimension, a shape, and an arrangement of which is known and a background in four or more wavelength ranges. The correction model generator is configured to generate a spectrum correction model by using training data based on a first reference spectrum and a second reference spectrum. The first reference spectrum is a spectrum of an image of the predetermined substance in the first reference image. The second reference spectrum is a spectrum of an image of the predetermined substance in the second reference image. The first reference image is obtained by imaging the predetermined substance at least one of a dimension, a shape, or an arrangement of which is known and which includes a portion having a width less than a threshold. The second reference image is obtained by imaging the predetermined substance at least one of a dimension, a shape, or an arrangement of which is known and which includes a portion having a width greater than or equal to the threshold. The spectrum correction model is a machine learning model for making a correction based on a spectrum of an image of a background to a spectrum of an image of an inspection target in an inspection target image. The inspection target image is obtained by imaging an object including the inspection target and the background in the four or more wavelength ranges.

A determination system according to an aspect of the present disclosure includes a correction model acquirer, an inspection image acquirer, a spectrum corrector, a spectrum determiner, and a result output. The correction model acquirer is configured to acquire a spectrum correction model from the model generation system. The inspection image acquirer is configured to acquire an inspection target image obtained by imaging an object including an inspection target and a background in four or more wavelength ranges. The spectrum corrector is configured to correct a first spectrum by using the spectrum correction model to generate a second spectrum. The first spectrum is a spectrum of an image of the inspection target in the inspection target image. The spectrum determiner is configured to determine, based on the second spectrum, whether or not the inspection target is a first substance. The result output is configured to output a determination result by the spectrum determiner.

An inspection method according to an aspect of the present disclosure includes: acquiring an inspection target image; making a correction based on a spectrum of an image of a background to a first spectrum to generate a second spectrum, the first spectrum being a spectrum of an image of an inspection target in the inspection target image; determining, based on the second spectrum, whether or not the inspection target is a predetermined substance; and outputting a determination result. The inspection target image is obtained by imaging an object including the inspection target and the background in four or more wavelength ranges.

A program according to an aspect of the present disclosure is a program configured to cause one or more processors to execute the inspection method.

A model generation method of an aspect of the present disclosure includes: acquiring a first reference image and a second reference image; and generating a spectrum correction model by using training data based on a first reference spectrum and a second reference spectrum. Each of the first reference image and the second reference image is obtained by imaging a predetermined substance at least one of a dimension, a shape, or an arrangement of which is known and a background in four or more wavelength ranges. The first reference spectrum is a spectrum of an image of the predetermined substance in the first reference image. The second reference spectrum is a spectrum of an image of the predetermined substance in the second reference image. The first reference image is obtained by imaging the predetermined substance at least one of a dimension, a shape, or an arrangement of which is known and which includes a portion having a width less than a threshold. The second reference image is obtained by imaging the predetermined substance at least one of a dimension, a shape, or an arrangement of which is known and which includes a portion having a width greater than or equal to the threshold. The spectrum correction model is a machine learning model for making a correction based on a spectrum of an image of a background to a spectrum of an image of an inspection target in an inspection target image. The inspection target image is obtained by imaging an object including the inspection target and the background in the four or more wavelength ranges.

A program according to an aspect of the present disclosure is a program configured to cause one or more processor to execute the model generation method.

### BRIEF DESCRIPTION OF DRAWINGS

FIG. 1 is a functional block diagram of an inspection system according to an embodiment;

FIG. 2 is a schematic view of an image obtained by imaging a first substance and a background;

FIG. 3A is a graph of a reflection spectrum of the first substance and a reflection spectrum of the background;

FIG. 3B is a graph of a spectrum of a pixel of the image of FIG. 2, the reflection spectrum of the first substance, and the reflection spectrum of the background;

FIG. 3C is a graph of a spectrum of a pixel, different from the pixel of FIG. 3B, of the image of FIG. 2, the reflection spectrum of the first substance, and the reflection spectrum of the background;

FIG. 4A is a schematic view of an example of an object for a first reference image;

FIG. 4B is a schematic view of an example of an object for a second reference image;

FIG. 5A is a schematic view of the first reference image obtained by imaging the object of FIG. 4A;

FIG. 5B is a schematic view of the second reference image obtained by imaging the object of FIG. 4B;

FIG. 5C is a graph of an example of a first reference spectrum and a second reference spectrum;

FIG. 6 is a schematic diagram of a relationship of an image of a physical body in the first reference image to a dimension, a shape, and an arrangement of the physical body;

FIG. 7 is a schematic view of an example of an object including an inspection target;

FIG. 8A is a schematic view of an inspection target image obtained by imaging the object of FIG. 7;

FIG. 8B is a graph of a relationship between a first spectrum and a second spectrum in the inspection target image of FIG. 8A;

FIG. 9 is a flowchart of operation of the inspection system;

FIG. 10 is a functional block diagram of an inspection system according to a first variation;

FIG. 11 is a functional block diagram of a model generation system according to a second variation;

FIG. 12 is a schematic view of an example of an object for a training image;

FIG. 13A is a schematic view of the training image obtained by imaging the object of FIG. 12;

FIG. 13B is a graph of a relationship between a first spectrum and a second spectrum in the training image; and

FIG. 14 is a flowchart of operation of the model generation system.

### DESCRIPTION OF EMBODIMENTS

An inspection system, an inspection method, a model generation system, a determination system, a model generation method, and a program according to an embodiment will be described below with reference to the drawings.

### EMBODIMENT

### 1. Overview of Inspection System

A configuration of an inspection system 100 according to an embodiment will be described with reference to the drawings.

### 1.1 Components of Inspection System

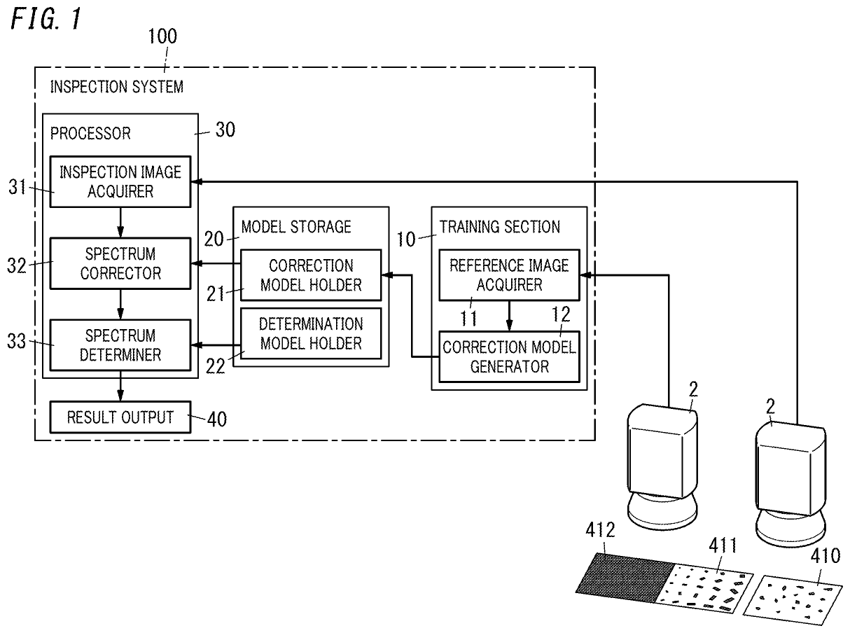

As shown in FIG. 1, the inspection system 100 according to the embodiment includes a training section 10, a model storage 20, and a processor 30. The training section 10 and the processor 30 are connected to respective imaging devices 2.

The inspection system 100 acquires a first reference image and a second reference image from its corresponding imaging device 2 to generate a spectrum correction model. Moreover, the inspection system 100 acquires an inspection target image from its corresponding imaging device 2, makes a spectrum correction based on a spectrum correction model to the inspection target image, and determines a substance of an object in the inspection target image. Each of the first reference image, the second reference image, and the inspection target image is a so-called multispectral image, or a so-called hyperspectral image, including pieces of light intensity information in four or more wavelength ranges.

### 1.2 Imaging Device

Each imaging device 2 is a camera configured to generate an image including the pieces of light intensity information in four or more wavelength ranges which do not overlap each other. The imaging device 2 is, for example, a spectral camera including a spectrometer configured to split light from the object into four or more spectra. The imaging device 2 is, for example, a so-called multi-spectrum camera or hyperspectral camera.

Wavelength ranges in which the imaging device 2 senses light intensity and reflects the light intensity in an image include a wavelength range required for identifying a first substance which is the inspection target of the inspection system 100. The wavelength range required for identifying the first substance includes, for example, a peak wavelength of an absorption spectrum of the first substance or a peak wavelength of a reflection spectrum of the first substance. Alternatively, the wavelength range required for identifying the first substance is, for example, a wavelength range in which the reflection spectrum of the first substance is significantly different from a reflection spectrum of another substance which has to be distinguished from the first substance.

Each of the wavelength ranges in which the imaging device 2 senses the light intensity and stores the light intensity as an image may be a visible light wavelength, or may be an ultraviolet wavelength or an infrared wavelength. For example, when silver which can be present in the vicinity of aluminum is the inspection target, each of the wavelength ranges may include a wavelength range from 300 μm to 400 μm and/or part of a wavelength range from 800 μm to 900 μm, in each of which a difference between a reflection spectrum of the aluminum and a reflection spectrum of the silver is significant.

The imaging device 2 outputs an image of an object imaged with the imaging device 2. The image includes pieces of light intensity information on pixels in each wavelength range. A piece of light intensity information on a pixel in each wavelength range is hereinafter referred to as a spectrum of the pixel.

### 2. Components of Inspection System

The training section 10, the model storage 20, the processor 30, and a result output 40, which are components of the inspection system 100, will be described in further detail below.

### 2.1 Training Section

A configuration and operation of the training section 10 will be described in further detail below.

### 2.1.1 Correction to Spectrum of Image

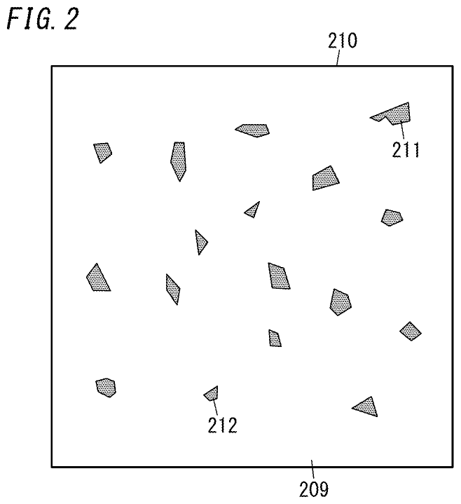

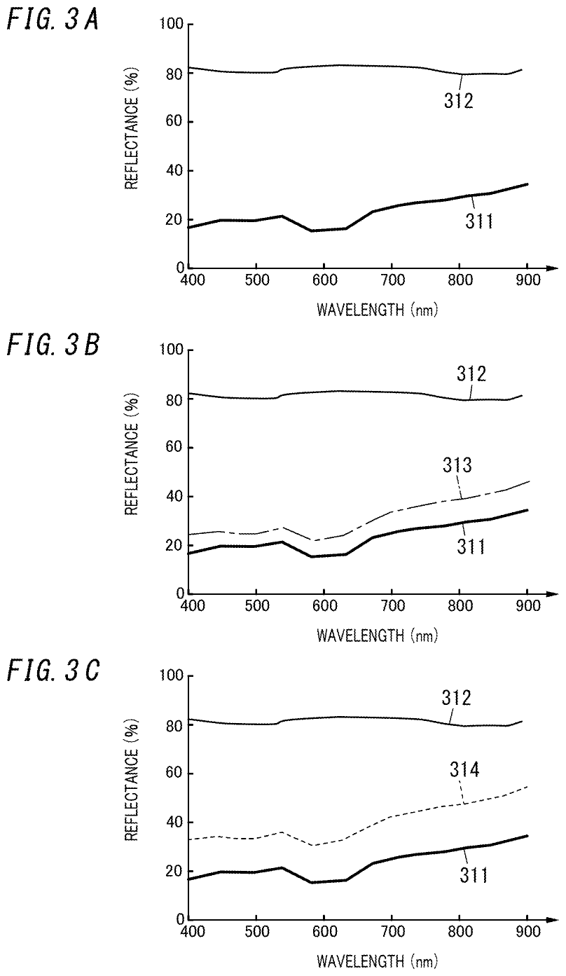

FIG. 2 is a schematic view of an inspection target image 210 obtained by imaging an object including: a first substance which is a substance of the inspection target; and a background. In the inspection target image 210 shown in FIG. 2, images 211 and 212 of the first substance are shown in black, and an image 209 of the background is shown in white. FIG. 3A is a graph of a reflection spectrum 311 of the first substance and a reflection spectrum 312 of the background. FIG. 3B is a graph in which a spectrum 313 of a pixel included in the image 211 of the first substance in the inspection target image 210 of FIG. 2 is shown in contrast to the reflection spectrum 311 and the reflection spectrum 312. FIG. 3C is a graph in which a spectrum 314 of a pixel included in the image 212 of the first substance in the inspection target image 210 of FIG. 2 is shown in contrast to the reflection spectrum 311 and the reflection spectrum 312.

As shown in FIGS. 3B and 3C, each of the spectrum 313 of the pixel in the image 211 of the first substance and the spectrum 314 of the pixel in the image 212 of the first substance does not necessarily coincide with the reflection spectrum 311 of the first substance. In addition, as shown in FIGS. 3B and 3C, although the image 211 and the image 212 are both images of the first substance, the spectrum 313 of the pixel in the image 211 does not necessarily coincide with the spectrum 314 of the pixel in the image 212. The reason for this is because in the inspection target image 210, light beams reflected off two types of substances are mixed with each other at a pixel in the vicinity of a boundary between images of the two types of substances.

That is, the spectrum of a pixel on, or in the vicinity of, a boundary between the image 211 of the first substance and the image 209 of the background is a mixture of the reflection spectrum 311 of the first substance and the reflection spectrum 312 of the background. The degree of mixing between the reflection spectrum 311 of the first substance and the reflection spectrum 312 of the background changes depending on a dimension, a shape, and an arrangement of the first substance.

For example, as the dimension of the first substance decreases, the degree of mixing of spectra increases at pixels on, and in the vicinity of, the boundary between each of the images 211 and 212 of the first substance and the image 209 of the background. The reason for this is because the closer to the boundary between each of the images 211 and 212 of the first substance and the image 209 of the background, the higher the degree of the mixing of the spectra, and therefore, when the dimension of the first substance is small, an area of a region in which the mixing of the spectra occurs is large with respect to an area occupied by the images 211 and 212 of the first substance.

Moreover, for a similar reason, the shape of the first substance varies the degree of the mixing of the spectra. That is, the longer boundary the shape has between each of the images 211 and 212 of the first substance and the image 209 of the background, the greater an influence of the mixing of the spectra over the pixels on, and in the vicinity of, the boundary between each of the images 211 and 212 of the first substance and the image 209 of the background. Thus, for example, the higher the ratio of a length in a long axis direction to a length in a short axis direction of the shape of the first substance, the greater the degree of the mixing of the spectra over the pixels on, and in the vicinity of, the boundary between each of the images 211 and 212 of the first substance and the image 209 of the background.

Moreover, when light is incident from a direction other than a direction orthogonal to the background, the shape and/or the location of a region in which the mixing of the spectra occurs differs in the inspection target image 210 depending on an angle formed between the long axis direction of the shape of the first substance and an incident direction of the light.

In view of the reason above, the training section 10 generates, from the spectrum of each pixel, a correction model for reducing the influence of the spectrum of the background in the inspection target image 210 obtained by imaging the object including the inspection target.

### 2.1.2 Configuration and Function of Training Section

Components of the training section 10 will be described below.

As shown in FIG. 1, the training section 10 includes a reference image acquirer 11 and a correction model generator 12. The reference image acquirer 11 is, for example, a combination of a processor, memory, and a program. Moreover, the correction model generator 12 is, for example, a combination of a processor, memory, and a program. Note that the processor of the reference image acquirer 11 and the processor of the correction model generator 12 may be an identical processor. The processor is, for example, a central processing unit (CPU) or a graphics processing unit (GPU).

### (1) Overview of Reference Image Acquirer

The reference image acquirer 11 acquires the first reference image, the second reference image, and a third reference image each of which satisfies the following condition. The first reference image, the second reference image, and the third reference image are hereinafter referred to as “reference images” when collectively mentioned. The reference image acquirer 11 acquires, from the reference images, pieces of information required for generation of the correction model and outputs the correction model to the correction model generator 12.

### (1.1) Details of First Reference Image

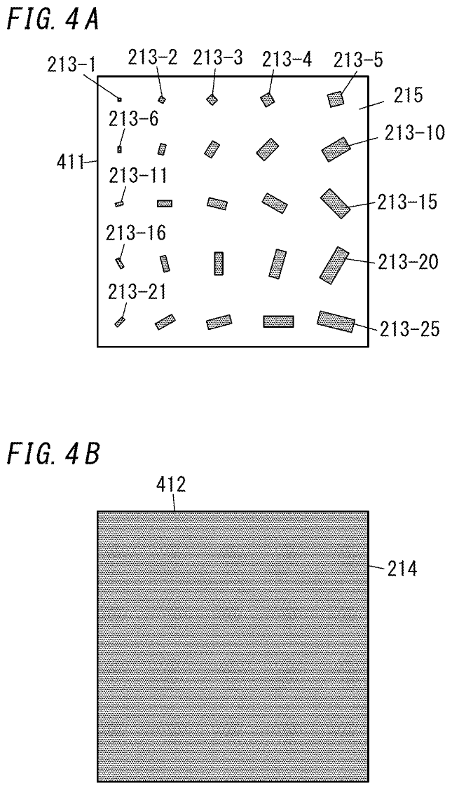

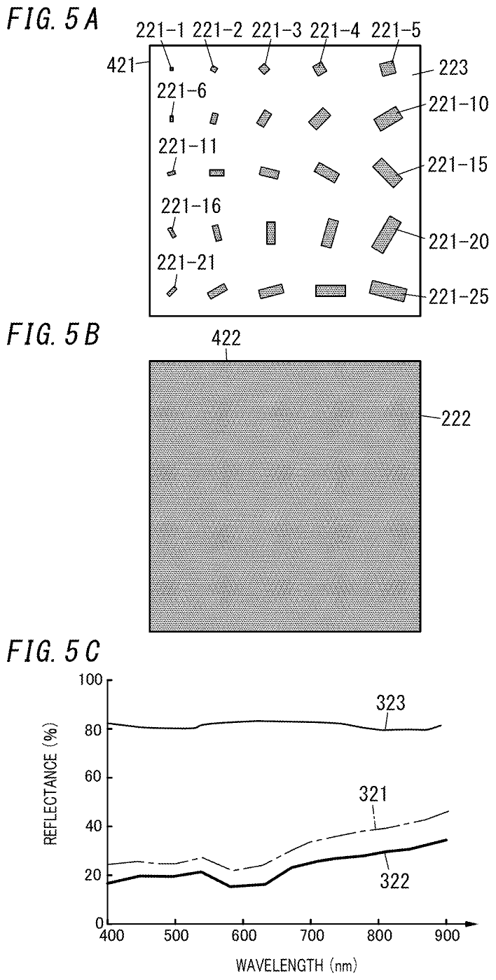

The reference image acquirer 11 acquires a first reference image 421 satisfying the following condition from the imaging device 2. The first reference image 421 (see FIG. 5A) is obtained by imaging an object 411 (see FIG. 4A) including a second substance 213 and a background 215 with the imaging device 2. The first reference image 421 is used to generate training data for generating the correction model. The second substance is a substance used to generate the training data for generating the correction model. The second substance is, for example, a substance identical with the first substance. Note that as described later, the second substance may be different from the first substance.

Moreover, the first reference image 421 includes one or more images respectively of one or more physical bodies 213 (see FIG. 4A) made of the second substance. The physical body 213 has a length (width) in the short axis direction thereof is less than a threshold. The threshold is set as follows. In an image taken of a state where a physical body made of a second substance and having a length (width) greater than or equal to the threshold in a short axis direction thereof is adjacent to a background, a degree of mixing of a reflection spectrum of the background with a spectrum of a pixel included in an image of the physical body is defined as a first mixing degree. In an image taken of a state where a physical body made of the second substance and having a length (width) less than the threshold in a short axis direction thereof is adjacent to a background, a degree of mixing of a reflection spectrum of the background with a spectrum of a pixel included in an image of the physical body is defined as a second mixing degree. The second mixing degree is higher than the first mixing degree. The threshold is, for example, 1 mm.

Note that the first reference image 421 may include a plurality of images of physical bodies 213. FIG. 4A shows an example of the object 411 for the first reference image 421 (see FIG. 5A). The object 411 includes physical bodies 213-1 to 213-25, and each of the physical bodies 213-1 to 213-25 satisfies the above-described condition for the physical body 213. FIG. 5A shows the first reference image 421 obtained by imaging the object 411 (see FIG. 4A). The first reference image 421 includes a plurality of images 221-1 to 221-25. The plurality of images 221-1 to 221-25 are images respectively of the physical bodies 213-1 to 213-25. The physical bodies 213-1 to 213-25 are hereinafter referred to as a “physical body 213” when they are not distinguished from each other. Moreover, the images 221-1 to 221-25 are referred to as an “image 221” when they are not distinguished from each other.

Note that the shape of the physical body 213 is not limited as long as the physical body 213 is made of the second substance and has a length (width) less than the threshold in the short axis direction. For example, the physical body 213 may be a particle of the second substance as shown in FIG. 4A. Alternatively, for example, the physical body 213 may be a test element group (TEG) pattern whose length (width) in the short axis direction is less than the threshold and which includes the second substance.

Moreover, in the first reference image 421, respective parameters representing a dimension, a shape, and an arrangement of the physical body 213 are known.

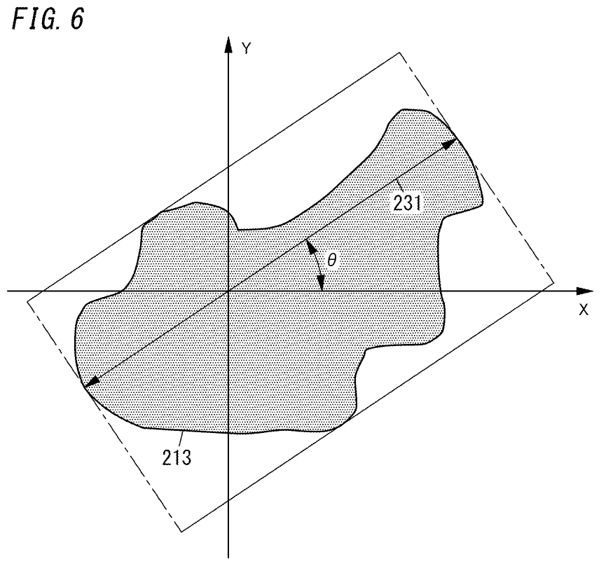

The parameter representing the dimension is, for example, a maximal diagonal distance. The maximal diagonal distance is the length of a maximum diagonal line. As shown in FIG. 6, a maximum diagonal line 231 is a line segment having a maximum length of line segments each connecting to each other two arbitrary points present on a boundary between the physical body 213 and the background 215 in plan view from the imaging device 2. For example, when the physical body 213 has an ellipse shape in plan view from the imaging device 2, the maximum diagonal line is a major axis of the ellipse. Alternatively, for example, when the physical body 213 has a parallelogram shape in plan view from the imaging device 2, the maximum diagonal line is a longer one of two diagonal lines of the parallelogram.

The parameter representing the shape is, for example, an area ratio obtained by dividing an area of the physical body 213 by a square of the maximal diagonal distance in plan view from the imaging device 2. For example, when the physical body 213 has a square shape in plan view from the imaging device 2, the area ratio is 50%. Moreover, for example, when the physical body 213 has a rectangular shape having an aspect ratio of 3:1 in plan view from the imaging device 2, the area ratio is 30%. In plan view from the imaging device 2, the higher ratio of an outer perimeter length to the area of the physical body 213 the shape of the physical body 213 has, the lower the area ratio.

The parameter representing the arrangement is, for example, a value indicating an orientation of the maximum diagonal line 231 with respect to an orientation of the first reference image 421. For example, when an angle θ formed between a direction of the maximum diagonal line and a direction serving as an x axis of the first reference image 421 is 20°, the value indicating the orientation is 20°.

### (1.2) Process on First Reference Image

The reference image acquirer 11 acquires the first reference image 421 satisfying the condition described above. The reference image acquirer 11 further acquires, for each physical body 213 which is the object for the first reference image 421, the respective parameters representing the dimension, the shape, and the arrangement of the physical body 213. The reference image acquirer 11 acquires, from a database (not shown), respective parameters which are acquired in advance, for example, in the preparation of the physical body 213 and which represent the dimension, the shape, and the arrangement of the physical body 213. Alternatively, the reference image acquirer 11 may calculate the respective parameters representing the dimension, the shape, and the arrangement of the physical body 213 by an image process as described later.

The reference image acquirer 11 acquires pieces of spectrum data on pixels included in each image 221 in the first reference image 421 as a first reference spectrum 321 (see FIG. 5C). The reference image acquirer 11 associates, for each image 221, the first reference spectrum 321 with the dimension, the shape, and the arrangement of the physical body 213 and then outputs the first reference spectrum 321 to the correction model generator 12. Note that for the first reference image 421 including the plurality of images 221, the reference image acquirer 11 associates, for each image 221, the first reference spectrum 321 of each image 221 with the dimension, the shape, and the arrangement of the physical body 213 and then outputs the first reference spectrum 321 to the correction model generator 12. Moreover, when the reference image acquirer 11 acquires a plurality of first reference images 421, the reference image acquirer 11 performs the process described above on each of the first reference images 421.

### (1.3) Method for Calculating Respective Parameters Representing Dimension, Shape, and Arrangement of Physical Body

The reference image acquirer 11 may perform the image process on the first reference image 421 and use a resolution of the first reference image 421 to calculate the respective parameters representing the dimension, the shape, and the arrangement of the physical body 213. The image process is, for example, as described below.

The reference image acquirer 11 extracts the image 221 from the first reference image 421 by, for example, an edge extraction process. Then, the reference image acquirer 11 detects a maximum diagonal line image of the image 221. The maximum diagonal line image is a line segment having a maximum length of line segments each connecting to each other two arbitrary points on an outer perimeter of the image 221. The maximum diagonal line image is an image of the maximum diagonal line 231, and therefore, based on the length of the maximum diagonal line image and the resolution of the first reference image 421, the reference image acquirer 11 calculates the maximal diagonal distance.

Moreover, the reference image acquirer 11 calculates the parameter representing the shape as described below. For example, the reference image acquirer 11 measures the number of pixels included in the image 221 and divides the number of pixels thus measured by a square of the length in pixels of the maximum diagonal line image, thereby calculating an area ratio of the image 221. The number of pixels included in the image 211 of the physical body 213 is proportional to the area of the physical body 213. Further, the square of the length of the maximum diagonal line image is proportional to the square of the length of the maximal diagonal distance. Furthermore, a ratio of the number of pixels included in the image 211 of the physical body 213 to the area of physical body 213 is equal to a ratio of the square of the length of the maximum diagonal line image to the square of the length of the maximal diagonal distance. Therefore, the area ratio of the image 211 is equal to an area ratio of the physical body 213. The reference image acquirer 11 calculates, alternatively to the area ratio of the physical body 213, the area ratio, which is the same value as the area ratio of the physical body 213, of the image 211.

Moreover, the reference image acquirer 11 calculates the parameter representing the arrangement as described below. For example, the reference image acquirer 11 calculates two coordinates serving as both ends of the maximum diagonal line image on the first reference image 421. Then, the reference image acquirer 11 divides a difference between y coordinates of the two coordinates on the first reference image 421 by the length of the maximum diagonal line image, thereby calculating a value (sin θ) of a sine of an angle θ formed between the direction of the maximum diagonal line image and the x axis of the first reference image 421. The reference image acquirer 11 calculates, from the value sine of the sine thus calculated, an angle θ formed between the direction of the maximum diagonal line image and the x axis of the first reference image 421.

### (1.4) Second Reference Image and Third Reference Image

The reference image acquirer 11 acquires a second reference image 422 satisfying the following condition from the imaging device 2. FIG. 4B shows an example of the object 412 for the second reference image 422. The object 412 includes a physical body 214. As shown in FIG. 5B, the second reference image 422 includes an image 222 of the physical body 214. The physical body 214 has a length (width) greater than or equal to a threshold in a short axis direction of the physical body 214 in plan view from the imaging device 2. That is, the width of the physical body 214 is necessarily greater than or equal to the threshold in plan view from the imaging device 2. As described above, a physical body whose length in a short axis direction of an object is greater than or equal to the threshold is less influenced by the spectrum of the background than a physical body whose length in the short axis direction of the object is less than the threshold. That is, the influence of the spectrum of the background 215 over the spectrum of the image 222 of the physical body 214 is smaller than the influence of the spectrum of the background 215 over the image 221 in the first reference image 421.

Note that the physical body 214 is at least such that the length (width) in the short axis direction of the physical body 214 is greater than or equal to the threshold in plan view from the imaging device 2. Thus, the physical body 214 may be, for example, a flat plate including a square, each side of which corresponds to the threshold in plan view from the imaging device 2. That is, the physical body 214 may be a bulk like the object 412 shown in FIG. 4B. Note that the physical body 214 may be in the shape of a particle or may be a TEG pattern as long as the length (width) in the short axis direction of the physical body 214 is greater than or equal to the threshold.

The reference image acquirer 11 acquires pieces of spectrum data on pixels included in the image 222 of the physical body 214 included in the second reference image 422 as a second reference spectrum 322 (see FIG. 5C).

The reference image acquirer 11 acquires the third reference image satisfying the following condition from the imaging device 2. In the present embodiment, the first reference image 421 taken of the object 411 including the background 215 is used also as the third reference image as shown in FIGS. 4A and 5A. The third reference image includes an image 223 of the background 215. The reference image acquirer 11 extracts pieces of spectrum data on pixels included in the image 223 of the background 215 in the third reference image as a reflection spectrum 323 (see FIG. 5C) of the background.

### (2) Overview of Correction Model Generator

The correction model generator 12 estimates the influence of the reflection spectrum of the background over the pieces of spectrum data by the following procedure. The first reference spectrum 321 of each of pixels included in an image 221-n of any physical body 213-n in the first reference image 421 is defined as a spectrum A1(n). An index n is an index indicating which physical body 213 is indicated. Further, the second reference spectrum 322 is defined as a spectrum A2. Furthermore, the reflection spectrum 323 of the background 215 is defined as a spectrum A3. A value α satisfying the following equality is defined as influence α of the background spectrum over the physical body 213-n.

$$A 1 ( n ) = α \times A 3 ( 1 - α ) \times A 2 \qquad ( Formula 1 )$$

Thus, the value of the influence α is given by the following formula.

$$α = \{ A 1 ( n ) - A 2 \} / \{ A 3 - A 2 \} \qquad ( Formula 2 )$$

The correction model generator 12 associates the value of the influence α calculated for each index n with respective parameters representing a dimension, a shape, and an arrangement of the physical body 213-n. Then, the correction model generator 12 generates, for machine learning, training data which uses the dimension, the shape, and the arrangement of the physical body 213 as input values and the value of the influence α as correct answer data. The correction model generator 12 generates a correction model by machine learning based on the training data thus generated. As a method of the machine learning, for example, a support-vector machine or a random forest may be used. Note that as long as the method of the machine learning is a learning method using training data, it may be an arbitrary method and may be, for example, a neural network. The machine learning using the training data generates a correction model which uses the dimension, the shape, and the arrangement of the physical body 213 as inputs and outputs the influence α of the background spectrum over the physical body 213.

The correction model generator 12 outputs the correction model thus generated to the correction model holder 21.

### 2.2 Model Storage

The model storage 20 includes a correction model holder 21 and a determination model holder 22.

The correction model holder 21 is a storage medium configured to hold the correction model described above and generated by the correction model generator 12. Note that the correction model holder 21 may hold a correction model acquired from another system. The another system includes, for example, a correction model generator 12. Alternatively, the another system includes, for example, a correction model holder 21. That is, the correction model holder 21 holds the correction model generated by the correction model generator 12 or the correction model generated by the another system.

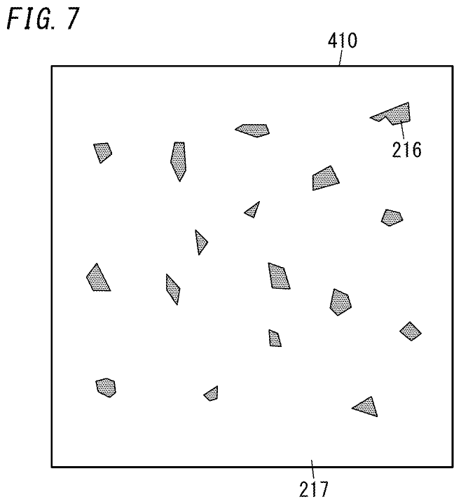

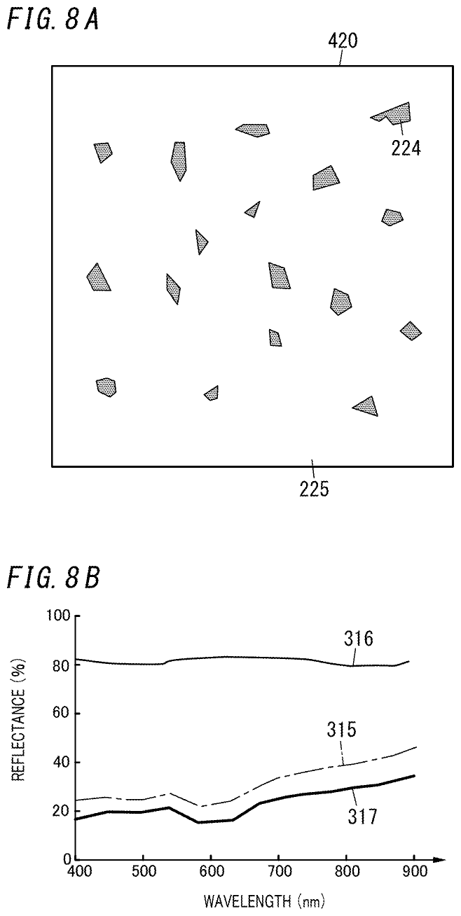

The determination model holder 22 is a storage medium configured to hold a determination model. The determination model is, in an inspection target image 420 (see FIG. 8) taken of an inspection target 216 (see FIG. 7), as described below, a model for identifying a substance of the inspection target 216 on the basis of a spectrum obtained by correcting the spectrum of each of pixels included in an image 224 of the inspection target.

### 2.3 Processor

As shown in FIG. 1, the processor 30 includes an inspection image acquirer 31, a spectrum corrector 32, and a spectrum determiner 33. Each of the inspection image acquirer 31, the spectrum corrector 32, and the spectrum determiner 33 is implemented by, for example, a computer including a processor and a program. Note that two or all of the inspection image acquirer 31, the spectrum corrector 32, and the spectrum determiner 33 may be implemented by using a single processor or may be implemented by a single computer.

### (1) Inspection Image Acquirer

The inspection image acquirer 31 acquires an inspection target image 420, as shown in FIG. 8A, including the image 224 of the inspection target 216 and an image 225 of a background 217 from the imaging device 2. The inspection target image 420 is an image taken of, for example, an object 410 shown in FIG. 7. The object 410 includes the inspection target 216 and the background 217. The inspection target image 420 includes the image 224 of the inspection target 216 and the image 225 of the background 217.

The inspection image acquirer 31 extracts one or more images 224 respectively of one or more inspection targets 216 and the image 225 of the background 217 by, for example, edge extraction. The inspection image acquirer 31 calculates, for each of the one or more images 224 respectively of the one or more inspection targets 216, a parameter representing a dimension, a parameter representing a shape, and a parameter representing an arrangement of each of the one or more images 224 by a method similar to that used in the reference image acquirer 11. The inspection image acquirer 31 acquires, as a first spectrum 315 (see FIG. 8B), a spectrum of each pixel included in the one or more images 224 respectively of the one or more inspection targets 216 included in the inspection target image 420. The inspection image acquirer 31 associates, for each of the one or more images 224 respectively of the one or more inspection targets 216 included in the inspection target image 420, the first spectrum 315 with the respective parameters representing the dimension, the shape, and the arrangement of the image 224 and then outputs the first spectrum 315 to the spectrum corrector 32. Moreover, the inspection image acquirer 31 outputs, to the spectrum corrector 32, a spectrum 316 of each of pixels included in the image 225 of the background 217 in the inspection target image 420 as the reflection spectrum of the background. Further, the inspection image acquirer 31 outputs the entirety of the inspection target image 420 to the spectrum corrector 32.

### (2) Spectrum Corrector

The spectrum corrector 32 makes, based on the correction model, a correction, which is for reducing the influence of a reflection spectrum 316 of the background, to the first spectrum 315 of each pixel included in the one or more images 224 respectively of the one or more inspection targets 216 in the inspection target image 420, thereby generating a second spectrum 317.

The spectrum corrector 32 acquires the correction model from the correction model holder 21. The spectrum corrector 32 estimates the value of the influence α of the background spectrum, for each of the one or more images 224 respectively of the one or more inspection targets 216 in the inspection target image 420, on the basis of the correction model and a combination of the respective parameters representing the dimension, the shape, and the arrangement of the image 224. This process calculates the value of the influence α of the background spectrum over the one or more images 224 on the basis of the estimation that when features which are a dimension, a shape, and an arrangement of an object are similar between the first reference image 421 and the inspection target image 420, the influence α of the background spectrum is also similar between the first reference image 421 and the inspection target image 420. The first spectrum 315 of each pixel included in the one or more images 224 respectively of the one or more inspection targets 216 in the inspection target image 420 is defined as a spectrum A4(m). The index m is an index indicating which of the plurality of images 224 is indicated. A spectrum A3 is the spectrum 316 of the image 225 of the background 217. Moreover, when the second spectrum 317 in which the influence of the background spectrum has been reduced is defined as a spectrum A5, the following equality holds true similarly to formula 1.

$$A 4 ( m ) = α \times A 3 + ( 1 - α ) \times A 5 \qquad ( Formula 3 )$$

Thus, the second spectrum 317 can be calculated by the following formula.

$$A 5 = \{ A 4 ( m ) - α \times A 3 \} / ( 1 - α ) \qquad ( Formula 4 )$$

For all pixels included in the image 224 of any of the one or more inspection targets 216 in the inspection target image 420, the spectrum corrector 32 calculates the influence α of the background spectrum and calculates the spectrum A5 which is the second spectrum 317. This process calculates, for each of the one or more images 224 in the inspection target image 420, the second spectrum 317 corrected based on the first spectrum 315 of each pixel included in the one or more images 224 and the spectrum 316 of each pixel included in the image 225 of the background 217 as shown in FIG. 8B. Over the second spectrum 317, the influence of the spectrum of the background is as little as that over the second reference spectrum 322 of the image 222 included in the second reference image 422.

The spectrum corrector 32 replaces, with the second spectra 317, the first spectra 315 of all pixels included in the image 224 of any of the one or more inspection targets 216 in the inspection target image 420, thereby generating a corrected image. The spectrum corrector 32 outputs the corrected image thus generated to the spectrum determiner 33.

Note that the spectrum corrector 32 may acquire the correction model from another system. The another system includes, for example, a correction model holder 21. Alternatively, the spectrum corrector 32 may include a storage for holding a correction model therein and may hold the correction model acquired from the correction model holder 21 or the another system.

### (3) Spectrum Determiner

The spectrum determiner 33 identifies, based on the second spectrum 317 of each pixel included in the one or more images 224 respectively of the one or more inspection targets 216, a substance of the one or more inspection targets 216 for the corrected image.

The spectrum determiner 33 acquires the corrected image from the spectrum corrector 32. The spectrum determiner 33 acquires the second spectrum 317 of each pixel included in the one or more images 224 respectively of the one or more inspection targets 216 from the corrected image. The spectrum determiner 33 acquires the determination model from the determination model holder 22. The determination model is a model for determining, based on the second spectrum 317 of each pixel included in the one or more images 224 respectively of the one or more inspection targets 216, the substance of the one or more inspection targets 216. The determination model is, for example, a machine learning model generated in advance by using training data which uses a reflection spectrum of a known substance as an input value and information identifying the substance as a correct answer. The information identifying the substance is, for example, the name, or abbreviated name, of the substance. Alternatively, the information identifying the substance may be, for example, information regarding a coincidence with the predetermined substance. The spectrum determiner 33 determines the substance of the one or more inspection targets 216 from the determination model and the second spectrum 317 of each pixel included in the one or more images 224 respectively of the one or more inspection targets 216.

### 2.4 Result Output

The result output 40 is a device which presents, to a user, a determination result of the substance of the one or more inspection targets 216 whose one or more images 224 are included in the inspection target image 420. The result output 40 is, for example, a display device.

The result output 40 puts different colors on the one or more images 224 of the one or more inspection targets 216 in the inspection target image 420, for example, depending on the types of substances of the one or more inspection targets 216 and then displays the one or more images 224. Moreover, for example, the result output 40 may display second spectrum of each of pixels of the inspection target image 420. For example, the result output 40 may be a touch panel, and when any pixel of the inspection target image 420 is touched, the result output 40 may present the second spectrum 317 of the pixel thus touched. Alternatively, for example, the result output 40 may be a touch panel, and when any pixel of the inspection target image 420 is touched, the result output 40 may present the first spectrum 315 and the second spectrum 317 of the pixel thus touched in the inspection target image 420 in an aspect in which the first spectrum 315 and the second spectrum 317 are comparable with each other. Moreover, for example, the result output 40 may display one of, or both, the first reference spectrum 321 and the second reference spectrum 322 of each pixel included in the image of the physical body 213 in the first reference image 421.

Note that the result output 40 is not limited to the display device but may be, for example, a database or a storage medium which stores a determination result of the substance of the one or more inspection targets 216 by the spectrum determiner 33.

### 3. Operation of Inspection System

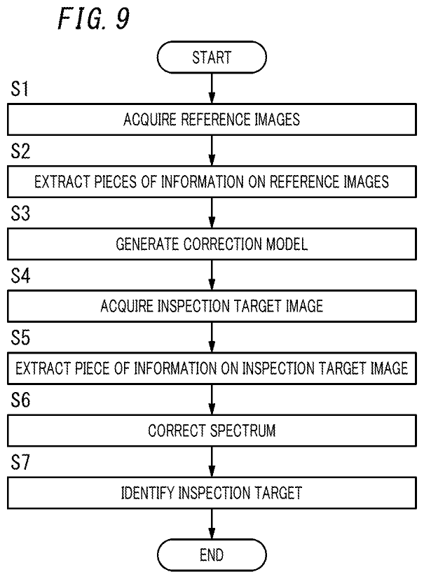

Operation of the inspection system 100 will be described below. FIG. 9 is a flowchart showing the operation of the inspection system 100 according to the embodiment.

The inspection system 100 acquires reference images (step S1). The reference image acquirer 11 of the inspection system 100 acquires the first reference image 421, the second reference image 422, and the third reference image which satisfy the condition described above. The reference image acquirer 11 acquires an image including the image 221 of the physical body 213 as the first reference image 421. Note that in order to improve the accuracy of the correction model, a plurality of images 221 of the physical bodies 213 are preferably acquirable from the first reference image 421. Thus, the reference image acquirer 11 acquires a plurality of first reference images 421 each including the image 221 of the physical body 213. Alternatively, the reference image acquirer 11 may acquire a first reference image 421 including a plurality of images 221 of the physical bodies 213. The reference image acquirer 11 further acquires an image including the image 222 of the physical body 214 as the second reference image 422.

Note that the reference image acquirer 11 may acquire as the first reference image 421, and may acquire as the second reference image 422, an image including the image 221 of the physical body 213 and the image 222 of the object 214. Moreover, the reference image acquirer 11 acquires an image including the image 223 of the background 215 as the third reference image. Note that the reference image acquirer 11 may acquire as the first reference image 421, and may acquire as the third reference image, an image including the image 221 of the physical body 213 and the image 223 of the background 215. Alternatively, the reference image acquirer 11 may acquire as the second reference image 422, and may acquire as the third reference image, an image including the image 222 of the physical body 214 and the image 223 of the background 215. Alternatively, the reference image acquirer 11 may acquire an image including the image 221 of the physical body 213, the image 222 of the object 214, and the image 223 of the background 215 as each of the first reference image 421, the second reference image 422, and the third reference image.

The reference image acquirer 11 acquires, for example, each of the reference images from the imaging device 2. Alternatively, the reference image acquirer 11 may acquire the reference images from an image holding system which holds images imaged with the imaging device 2.

Then, the inspection system 100 extracts pieces of information on the reference images (step S2). The reference image acquirer 11 of the inspection system 100 identifies images 221 of a plurality of physical bodies 213 from one or a plurality of first reference images 421. The reference image acquirer 11 acquires, for each of the plurality of physical bodies 213, the respective parameters representing the dimension, the shape, and the arrangement of each physical body 213. The reference image acquirer 11 calculates the respective parameters representing the dimension, the shape, and the arrangement of each physical body 213 by performing the image process described above on each of the one or more first reference images 421 each including the images 221 of the physical bodies 213 as described above and based on the resolution of each of the one or more first reference images 421. Alternatively, for example, the reference image acquirer 11 may receive an input for one or more of the respective parameters representing the dimension, the shape, and the arrangement of each physical body 213 from a user. Still alternatively, for example, the reference image acquirer 11 may acquire one or more of the respective parameters representing the dimension, the shape, and the arrangement of the physical body 213, together with the reference images, from the image holding system.

The reference image acquirer 11 associates, for each of the plurality of physical bodies 213, the first reference spectrum 321 which is the spectrum of each pixel included in the image 221 of each physical body 213 with the respective parameters representing the dimension, the shape, and the arrangement of each physical body 213, and then outputs the first reference spectrum 321 to the correction model generator 12. Moreover, the reference image acquirer 11 outputs the spectrum of each pixel included in the image 222 of the physical body 214 in the second reference image 422 as the second reference spectrum 322 to the correction model generator 12. Further, the reference image acquirer 11 outputs the spectrum of each pixel included in the image 223 of the background 215 in the third reference image to the correction model generator 12. Note that the inspection system 100 may output a known reflection spectrum of the second substance, alternatively to the second reference spectrum 322, to the correction model generator 12. Moreover, the inspection system 100 may output a known reflection spectrum of the background 215, alternatively to the spectrum of each pixel of the image 223 of the background 215 in the third reference image to the correction model generator 12.

Then, the inspection system 100 generates a correction model (step S3). The correction model generator 12 of the inspection system 100 calculates the influence α of the background spectrum over the first reference spectrum 321 of each of the physical bodies 213. The correction model generator 12 calculates the influence α of the background spectrum by using the second reference spectrum 322, the spectrum of each pixel of the image 223 of the background 215 in the third reference image, and the first reference spectrum 321. Then, the correction model generator 12 associates, for each of the plurality of physical bodies 213, the influence α of the background spectrum over the first reference spectrum 321 with the respective parameters representing the dimension, the shape, and the arrangement of the physical body 213. This process generates, for machine learning, training data which uses the respective parameters representing the dimension, the shape, and the arrangement of the physical body 213 as input values and the influence α of the background spectrum as correct answer data. The correction model generator 12 generates the correction model by machine learning based on the training data. The correction model generator 12 outputs the correction model thus generated to the correction model holder 21.

Then, the inspection system 100 acquires the inspection target image 420 (step S4). The inspection image acquirer 31 of the inspection system 100 acquires, as the inspection target image 420, an image including the one or more images 224 respectively of the one or more inspection targets 216 from the imaging device 2.

Then, the inspection system 100 extracts a piece of information on the inspection target image 420 (step S5). The inspection image acquirer 31 of the inspection system 100 extracts, from the inspection target image 420, the one or more images 224 respectively of the one or more inspection targets 216 and the image 225 of the background 217. For each of the one or more inspection targets 216, the inspection image acquirer 31 calculates, based on the one or more images 224 respectively of the one or more inspection targets 216, a parameter representing a dimension, a parameter representing a shape, and a parameter representing an arrangement of each of the one or more inspection targets 216 by a method similar to that used in the reference image acquirer 11. The inspection image acquirer 31 outputs, for each of the one or more inspection targets 216, a combination of the respective parameters representing the dimension, the shape, and the arrangement of each of the one or more inspection targets 216 and the first spectrum 315 of each pixel included in the one or more images 224 respectively of the one or more inspection targets 216 to the spectrum corrector 32. Moreover, the inspection image acquirer 31 outputs the spectrum of each pixel included in the image 225 of the background 217 of the inspection target image 420 as the spectrum 316 of the image 225 of the background 217 to the spectrum corrector 32. Further, the inspection image acquirer 31 outputs the entirety of the inspection target image 420 to the spectrum corrector 32.

Then, the inspection system 100 corrects the spectrum (step S6). The spectrum corrector 32 of the inspection system 100 acquires the correction model from the correction model holder 21. The spectrum corrector 32 estimates, for each of the one or more inspection targets 216 of the inspection target image 420, the influence α of the background spectrum over the first spectrum 315 by using the correction model from the respective parameters representing the dimension, the shape, and the arrangement of the one or more inspection targets 216. The spectrum corrector 32 corrects, based on the influence α of the background spectrum thus estimated for each of the one or more inspection targets 216, the first spectrum 315 of each pixel included in the one or more images 224 respectively of the one or more inspection targets 216, thereby generating the second spectrum 317. The second spectrum 317 is generated based on the assumption that the first spectrum 315 of each pixel included in the one or more images 224 respectively of the one or more inspection targets 216 is formed by influence which corresponds to the influence α of the background spectrum and which is exerted by the spectrum 316 of the background over the second spectrum 317. That is, the second spectrum 317 is a spectrum obtained by reducing the influence of the spectrum 316 of the background exerted over the first spectrum 315 of each pixel included in the one or more images 224 to the same extent as that over the second reference spectrum.

The spectrum corrector 32 generates a corrected image for the inspection target image 420. The corrected image is an image in which the first spectra 315 of all pixels included in the one or more images 224 respectively of the one or more inspection targets 216 have been replaced with the second spectrum 317. The spectrum corrector 32 outputs the corrected image to the spectrum determiner 33.

Then, the inspection system 100 identifies the inspection target 216 (step S7). The spectrum determiner 33 of the inspection system 100 identifies, for the corrected image, the substance of the one or more inspection targets 216 on the basis of the second spectrum 317 of each pixel included in the one or more images 224 respectively of the one or more inspection targets 216. As described above, the second spectrum 317 is a spectrum from which the influence of the spectrum 316 of the background has been reduced to the same extent as that over the first reference spectrum. Thus, the second spectrum 317 is more similar to the reflection spectrum of the substance constituting the one or more inspection targets 216 than to the first spectrum 315. The method of identifying the substance is, for example, a method using a determination model by machine learning. Alternatively, the method of identifying the substance may be, for example, checking against the reflection spectrum of the known substance.

The processes described above determines the substance of the one or more inspection targets 216.

### 4. Effects

The inspection system 100 according to the embodiment determines, based on an image including pieces of light intensity information in four or more wavelength ranges, the substance of the one or more inspection targets 216. One or more of the four or more wavelength ranges may be included in the ultraviolet region or the infrared region. Thus, inspections can be performed on substances difficult to be visually distinguished from each other, such as determination of the substance of metal present in the vicinity of a different type of metal and determination of the substance of a resin present in the vicinity of a different type of resin.

Moreover, in the inspection system 100 according to the embodiment, the spectrum corrector 32 corrects, based on the correction model, the first spectrum 315 of each pixel included in the one or more images 224 respectively of the one or more inspection targets 216 in the inspection target image 420. Thus, the spectrum determiner 33 can determine, based on the second spectrum 317 from which the influence of the spectrum 316 of the background has been reduced, the substance of the one or more inspection targets 216. This can prevent the accuracy of determination of the substance of the inspection target 216 from decreasing due to mixing of the spectrum 316 of the background with a first spectrum 315 of each of the one or more images 224 respectively of the one or more inspection targets 216. Thus, the accuracy of the determination of the inspection target 216 can be improved.

Moreover, the training section 10 according to the embodiment generates the correction model which uses a combination of the respective parameters representing the dimension, the shape, and the arrangement of the physical body 213 as an input and the influence α of the background spectrum as an output. That is, based on the estimation that when the dimension, the shape, and the arrangement of the object are similar between the first reference image 421 and the inspection target image 420, the influence α of the background spectrum is also similar between the first reference image 421 and the inspection target image 420, the value of the influence α of the background spectrum over the one or more images 224 respectively of the one or more inspection targets 216 is calculated. Thus, preparing wide variety of pieces of training data for generating the correction model can easily improve the correction accuracy and can thus improve the determination accuracy of the substance of the one or more inspection targets 216.

Moreover, in the inspection system 100 according to the embodiment, the influence α of the background spectrum over the first reference spectrum 321 of the image 221 of the physical body 213 in the first reference image 421 is represented by the ratio of the spectrum of the background to the first reference spectrum 321. That is, the influence α of the background spectrum is independent of the features and/or the intensity of the reflection spectrum 311 of the first substance. Thus, as long as the influence α of the background spectrum over the first substance and the second substance can be estimated to be the same extent, the second substance which is an object for the first reference image 421 does not have to be the same as the first substance, which is to be identified, of the inspection target 216 which is an object for the inspection target image 420. For example, when the substance of the background is a resin and the second substance and the first substance are both metal materials, it can be estimated that even when the first substance and the second substance are different types of metal, the influence α of the background spectrum is the same extent. That is, by using, for example, a correction model generated by using iron as the second substance, the spectrum correction by the spectrum corrector 32 can presumably reduce the influence of the reflection spectrum of the background even in the case of the first substance being silver. Thus, the correction model using the same type of substance as the second substance does not have to be generated for each of types of the first substances, thereby saving labor for generating the correction model.

Moreover, in the inspection system 100 according to the embodiment, the spectrum determiner 33 can determine, based on the second spectrum 317 from which the influence of the spectrum 316 of the background has been reduced, the substance of the one or more inspection targets 216. Thus, when the determination model is generated by machine learning, using a spectrum of a sample over which little influence is exerted by the spectrum 316 of the background and whose width in the short axis direction is greater than or equal to the threshold can easily improve the determination accuracy. Moreover, to generate the training data for generating the determination mode, a spectrum of a sample including a portion whose width in the short axis direction is less than the threshold does not have to be used, thereby saving labor for generating the determination model. Further, using no training data including, as an input, a spectrum significantly influenced by the spectrum 316 of the background prevents the accuracy of the determination model from decreasing.

Note that in the spectrum determiner 33 according to the embodiment, the influence of the spectrum 316 of the background is little over the second spectrum 317 of each pixel included in the one or more images respectively of the one or more inspection targets 216 in the corrected image. Thus, the determination model is not limited to a model generated by machine learning. For example, the determination model holder 22 holds the reflection spectrum of the known substance. The spectrum determiner 33 calculates the degree of coincidence between the second spectrum 317 of each pixel included in the one or more images respectively of the one or more inspection targets 216 in the corrected image and the reflection spectrum of the known substance held by the determination model holder 22. If the degree of coincidence is higher than a predetermined threshold, the spectrum determiner 33 determines that the one or more inspection targets 216 is the known substance. For the determination of the degree of coincidence, for example, a correlation process may be used. Such a process can also identify the substance of the one or more inspection targets 216.

### First Variation

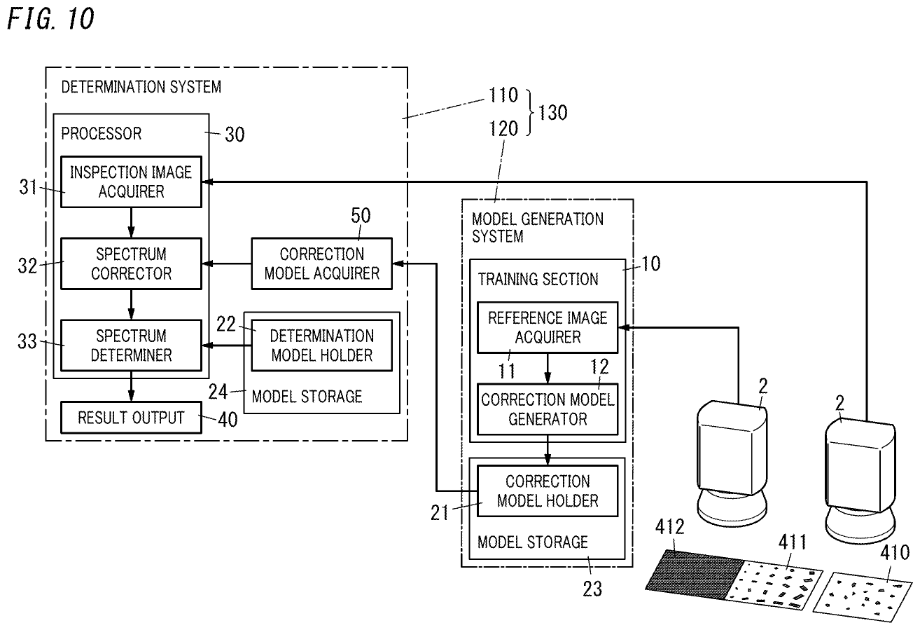

As shown in FIG. 10, an inspection system 130 according to a first variation is different from the inspection system 100 (see FIG. 1) according to the embodiment in that the inspection system 130 includes a determination system 110 and a model generation system 120.

As shown in FIG. 10, the model generation system 120 includes a training section 10 and a model storage 23. The training section 10 has the same functions as the training section 10 (see FIG. 1) of the inspection system 100 according to the embodiment. Thus, the detailed description of the training section 10 is omitted. The model storage 23 includes a correction model holder 21. The correction model holder 21 has the same functions as the correction model holder 21 (see FIG. 1) of the inspection system 100 according to the embodiment. Thus, the detailed description of the correction model holder 21 is omitted. That is, the model generation system 120 has the same configuration as the inspection system 100 from which the processor 30 and the determination model holder 22 are removed. The model generation system 120 performs operation of generating a correction model by using the first reference image 421, the second reference image 422, and the third reference image in the inspection system 100. That is, the model generation system 120 performs operation from steps S1 to S3 in the flowchart of FIG. 9.

As shown in FIG. 10, the determination system 110 includes a processor 30, a result output 40, a correction model acquirer 50, and a model storage 24. The result output 40 has the same functions as the result output 40 (see FIG. 1) of the inspection system 100 according to the embodiment. Thus, the detailed description of the result output 40 is omitted. Moreover, the processor 30 has the same functions as the processor 30 (see FIG. 1) of the inspection system 100 except that a spectrum corrector 32 is configured to acquire the correction model not from the correction model holder 21 but from the correction model acquirer 50. The model storage 24 includes a determination model holder 22. The determination model holder 22 has the same functions as the determination model holder 22 (see FIG. 1) according to the inspection system 100. The correction model acquirer 50 is a function block configured to acquire the correction model from the correction model holder 21 of the model generation system 120 and is, for example, a communication device configured to communicate with the correction model holder 21 of the model generation system 120. That is, the determination system 110 has the same configuration as the inspection system 100 from which the training section 10 and the correction model holder 21 are removed and to which the correction model acquirer 50 is added. The determination system 110 performs the operation, in the inspection system 100, of correcting the spectrum of the inspection target image 420 by using the correction model to determine the substance of the inspection target 216. That is, the determination system 110 performs operation from steps S4 to S7 in the flowchart of the FIG. 9.

As described above, the inspection system 130 according to the first variation generates the correction model by the model generation system 120, and the determination system 110 determines the substance of the inspection target 216 by using the correction model. That is, the operation of the inspection system 100 according to the embodiment is carried out by a combination of the determination system 110 and the model generation system 120.

The present variation can also provide an effect similar to that provided by the inspection system 100 according to the embodiment. Moreover, in the present variation, for example, the correction model generated by a single model generation system 120 can be used by a plurality of determination systems 110. Thus, correction models do not have to be generated for respective determination systems 110, thereby saving labor for generating the correction model.

Note that in the first variation, the model generation system 120 includes the correction model holder 21, and the determination system 110 include the correction model acquirer 50. Alternatively to this configuration, the model generation system 120 may include the correction model transmitter, and the determination system 110 may include the correction model holder 21. Alternatively, for example, the inspection system 130 may include a model storing system, the model generation system 120 may output the correction model to the model storing system, and the determination system 110 may acquire the correction model from the model storing system. The model storing system is, for example, a server on a network. Alternatively, the model storing system may be, for example, a storage medium.

### Second Variation

### 1. Configuration

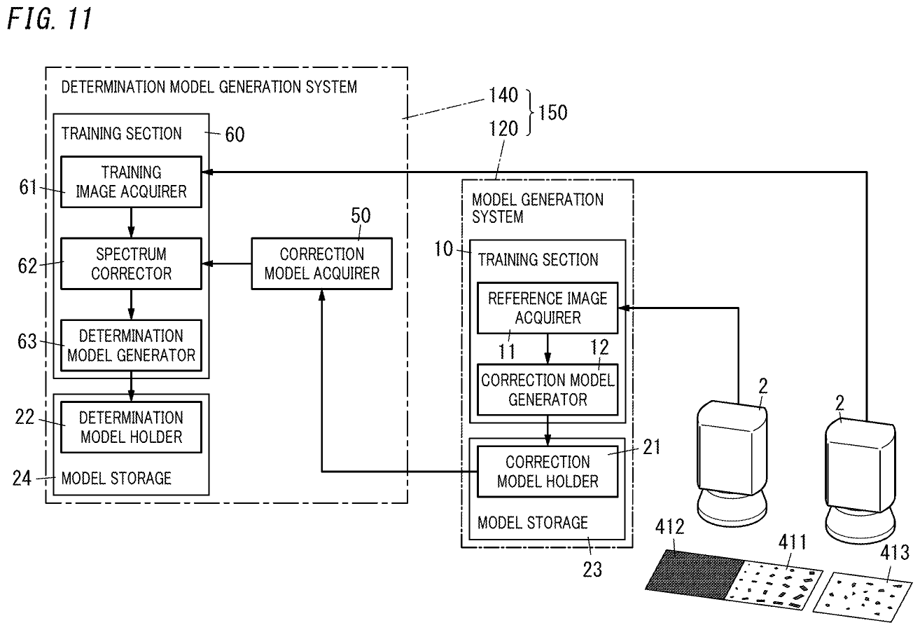

As shown in FIG. 11, a model generation system 150 according to a second variation is different from the model generation system 120 (see FIG. 10) of the first variation in that the model generation system 150 further includes a determination model generation system 140.

The model generation system 150 according to the second variation includes a correction model generation system 120 and the determination model generation system 140. The correction model generation system 120 is the same as the model generation system 120 according to the first variation. Thus, the detailed description of the correction model generation system 120 is omitted.

As shown in FIG. 11, the determination model generation system 140 includes a model storage 24, a correction model acquirer 50, and a training section 60.

The training section 60 acquires a training image taken of an inspection target, thereby generating a determination model. The training section 60 includes a training image acquirer 61, a spectrum corrector 62, and a determination model generator 63.

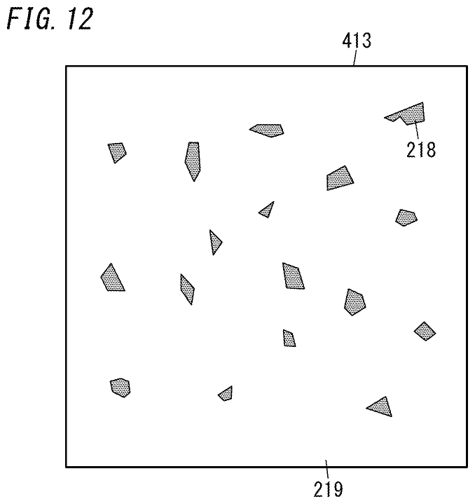

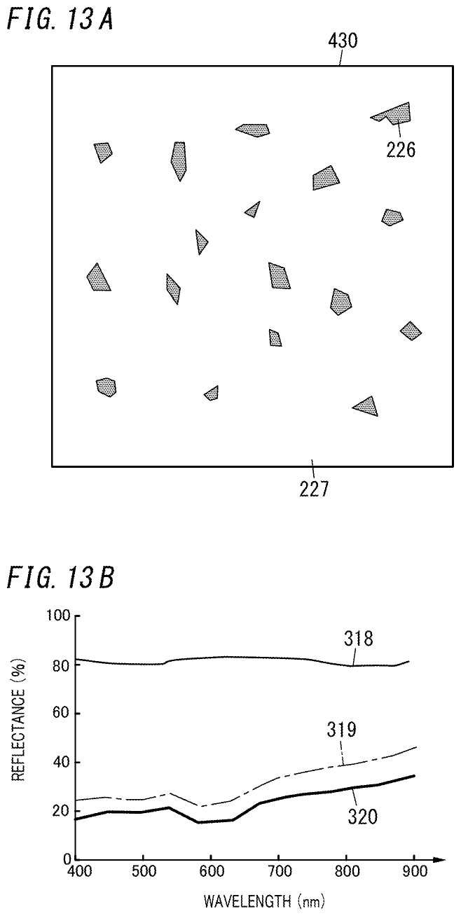

The training image acquirer 61 acquires a training image 430 (see FIG. 13A). The training image 430 is an image obtained by imaging an object 413 (see FIG. 12) including a first substance 218 and a background 219 with the imaging device 2. The training image acquirer 61 extracts one or more images 226 respectively of one or more first substances 218 and an image 227 of the background 219 by, for example, edge extraction. The training image acquirer 61 calculates, for each of the one or more first substances 218, a parameter representing a dimension, a parameter representing a shape, and a parameter representing an arrangement of each of the one or more first substances 218 by a method similar to that used in the reference image acquirer 11. The training image acquirer 61 acquires, for each of the one or more first substances 218, the spectrum of each of pixels included in the one or more images 226 respectively of the one or more first substances 218 in the training image 430 as a first spectrum 319. The training image acquirer 61 associates, for each of the one or more first substances 218, the first spectrum 319 with the respective parameters representing the dimension, the shape, and the arrangement of each of the one or more first substances 218 and then outputs the first spectrum 319 to the spectrum corrector 62. Moreover, the training image acquirer 61 outputs the spectrum of each of pixels included in the image 227 of the background 219 in the training image 430 as a reflection spectrum 318 (see FIG. 13B) of the background to the spectrum corrector 62. Moreover, the training image acquirer 61 outputs the entirety of the training image 430 to the spectrum corrector 62.

Similarly to the spectrum corrector 32 according to the embodiment, the spectrum corrector 62 corrects a first spectrum 319 of the one or more images 226 respectively of the one or more first substances 218 in the training image 430. The spectrum corrector 62 estimates for each of the one or more images 226 respectively of the one or more first substances 218, the value of influence α of the background spectrum on the basis of the correction model and a combination of the respective parameters representing the dimension, the shape, and the arrangement of the first substance 218. This process calculates the value of the influence α of the background spectrum in the training image 430 on the basis of the estimation that when the dimension, the shape, and the arrangement of the object are similar between the first reference image 421 and the training image 430, the extent of the influence α of the background spectrum is similar between the first reference image 421 and the training image 430.

The spectrum corrector 62 calculates, for all pixels included in the image 226 of any of the one or more first substances 218 in the training image 430, the influence α of the background spectrum. Similarly to the spectrum corrector 32, the spectrum corrector 62 calculates a second spectrum 320 of each pixel on the basis of the reflection spectrum 318 of the background as well as the influence α of the background spectrum over, and the first spectrum 319 of, each pixel. The spectrum corrector 62 outputs an image obtained by replacing, with the second spectra 320, the first spectra 319 of all pixels, included in the image 226 of any of the one or more first substances 218, of pixels included in the training image 430 as a corrected image to the determination model generator 63.

The determination model generator 63 generates training data which uses the second spectrum 320 of each pixel included in the one or more images 226 respectively of the one or more first substances 218 in the corrected image as an input data and information representing the first substance as a correct answer. The determination model generator 63 generates a determination model by machine learning using the training data described above. As the machine learning, for example, a support-vector machine or a random forest may be used. Note that the machine learning is not limited to this example, but as long as the machine learning uses training data, arbitrary machine learning may be used, and the machine learning may be, for example, a neural network. The determination model generator 63 outputs the determination model thus generated to the determination model holder 22.

### 2. Operation

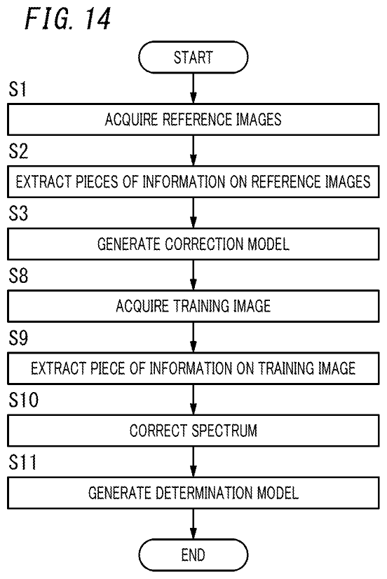

Operation of the model generation system 150 will be described below. FIG. 14 is a flowchart of the operation of the model generation system 150 according to the second variation. Note that operation steps the same as those of the inspection system 100 shown in FIG. 9 are denoted by the same step number as that in FIG. 9, and the detailed description thereof is omitted.

The model generation system 150 acquires reference images (step S1). A reference image acquirer 11 of the model generation system 150 acquires a first reference image 421, a second reference image 422, and a third reference image. The details of this step are the same as those in the embodiment and are thus omitted.

Then, the model generation system 150 extracts pieces of information on the reference images (step S2). The reference image acquirer 11 of the model generation system 150 extracts pieces of information required for generation of a correction model from the first reference image 421, the second reference image 422, and the third reference image. The details of this step are the same as those in the embodiment and are thus omitted.

Then, the model generation system 150 generates the correction model (step S3). A correction model generator 12 of the model generation system 150 generates the correction model on the basis of the pieces of information extracted from the reference images. The details of this step are the same as those in the embodiment and are thus omitted.

Then, the model generation system 150 acquires the training image 430 (step S8). The training image acquirer 61 of the model generation system 150 acquires the training image 430 taken of the object 413 including the first substance 218 and the background 219 from the imaging device 2.

Then, the model generation system 150 extracts a piece of information on the training image 430 (step S9). The training image acquirer 61 of the model generation system 150 extracts, from the training image 430, the one or more images 226 respectively of the one or more first substances 218 and the image 227 of the background 219. The training image acquirer 61 calculates, for each of the one or more first substances 218, respective parameters representing the dimension, the shape, and the arrangement of each of the one or more first substances 218 on the basis of the one or more images 226. The training image acquirer 61 acquires, for each of the one or more first substances 218, the spectrum of each pixel included in the one or more images 226 respectively of the one or more first substances 218 in the training image 430 as the first spectrum 319. The training image acquirer 61 associates, for each of the one or more first substances 218, the first spectrum 319 with the respective parameters representing the dimension, the shape, and the arrangement of the first substance 218 and then outputs the first spectrum 319 to the spectrum corrector 62. Moreover, the training image acquirer 61 outputs the spectrum of each pixel included in the image 227 of the background 219 in the training image 430 as the reflection spectrum 318 of the background to the spectrum corrector 62. Moreover, the training image acquirer 61 outputs the entirety of the training image 430 to the spectrum corrector 62.

Then, the model generation system 150 corrects the spectrum (step S10). The spectrum corrector 62 of the model generation system 150 estimates, for each of the one or more first substances 218, the value of the influence α of the background spectrum on the basis of the correction model and a combination of the respective parameters representing the dimension, the shape, and the arrangement of each of the one or more first substances 218. The spectrum corrector 62 calculates the second spectrum 320 of each pixel on the basis of the reflection spectrum 318 of the background 219 and the influence α of the background spectrum over, and the first spectrum 319 of, each pixel. The spectrum corrector 62 outputs an image obtained by replacing, with the second spectra 320, the first spectra 319 of all pixels, included in the image 226 of any of the one or more first substances 218, of pixels included in the training image 430 as a corrected image to the determination model generator 63.

Then, the model generation system 150 generates the determination model (step S11). The determination model generator 63 of the model generation system 150 generates training data which uses the second spectrum 320 of each pixel included in the one or more images 226 respectively of the one or more first substances 218 in the corrected image as an input data and information representing the first substance as a correct answer. The determination model generator 63 generates a determination model by machine learning using the training data described above.

The processes described above generates the determination model for determining the first substance by using the second spectrum 320 as an input.

### 3. Effects

The determination model according to the second variation is a machine learning model for determining the first substance on the basis of the second spectrum 320. Thus, using the determination model according to the second variation in the inspection system 100 according to the embodiment or the determination system 110 according to the first variation can improve the determination accuracy of the first substance. In particular, since similar corrections are made to the second spectrum 320 for generating the determination model and the second spectrum 317 in the determination system, the influence of the spectrum of the background can be reduced.

Moreover, similarly to the embodiment, the influence of the spectrum 318 of the background over the second spectrum 320 after the correction by the spectrum corrector 62 has been reduced to the same extent as that over the second reference spectrum as compared with the first spectrum 319 of each pixel of the training image 430. That is, in an input in the training data of the determination model, the influence of the spectrum 318 of the background is little. Thus, the influence of the background spectrum in the determination model can be reduced. That is, the accuracy of the determination model can be improved.

### Other Variations According to Embodiment

(1) In the embodiment and the variations, the reference image acquirer 11 calculates, for the second substance 213, the maximal diagonal distance as the dimension, the area ratio as the shape, and the angle formed between the maximum diagonal line and the x axis as the arrangement. The correction model generator 12 generates the correction model which uses the dimension, the shape, and the arrangement as inputs. The inspection image acquirer 31 calculates, based on each of the one or more images 224 respectively of the one or more inspection targets 216, the dimension, the shape, and the arrangement of each of the one or more inspection targets 216, and the spectrum corrector 32 corrects the spectrum by using the dimension, the shape, and the arrangement of each of the one or more inspection targets 216.

The input to the correction model is, however, not limited to the examples described above. The input to the correction model may be an arbitrary element which influences over the value of the influence α of the spectrum of the background with respect to the first reference spectrum of the image 221 of the second substance 213 of the first reference image 421 or the first spectrum of each of the one or more images 224 respectively of the one or more inspection targets 216 of the inspection target image 420. Moreover, the element used as the input to the correction model may be one or more of, or an element other than, the dimension, the shape, and the arrangement.

(2) In the embodiment and each variation, the correction model generator 12 uses the second reference spectrum 322 of the image 222 of the physical body 214 in the second reference image 422 as the reflection spectrum of the second substance. Moreover, the correction model generator 12 uses the reflection spectrum 323 of the image 223 of the background 215 in the third reference image as the reflection spectrum of the background. However, the correction model generator 12 may use the reflection spectrum of the second substance and the reflection spectrum of the background which are pieces of known data. In this case, the reference image acquirer 11 may output also the image of the physical body 214 in the second reference image 422 in combination with the respective parameters representing the dimension, the shape, and the arrangement of the physical body 214. Moreover, the correction model generator 12 may calculate, for the image of the physical body 214 in the second reference image 422, the influence α of the background spectrum, and may use the influence α, as part of the training data for generating the correction model.

### SUMMARY

An inspection system (100; 130) of a first aspect includes an inspection image acquirer (31), a spectrum corrector (32), a spectrum determiner (33), and a result output (40). The inspection image acquirer (31) is configured to acquire an inspection target image (420). The inspection target image (420) is obtained by imaging an object (410) including an inspection target (216) and a background (217) in four or more wavelength ranges. The spectrum corrector (32) is configured to make a correction based on a spectrum (316) of an image (225) of the background (217) to a first spectrum (315) to generate a second spectrum (317). The first spectrum (315) is a spectrum of an image (224) of the inspection target (216) in the inspection target image (420). The spectrum determiner (33) is configured to determine, based on the second spectrum (317), whether or not the inspection target (216) is a first substance. The result output (40) is configured to output a determination result by the spectrum determiner (33).

The inspection system (100; 130) of the first aspect enables a reduction in the influence of the spectrum (316) of the image (225) of the background (217) over the accuracy of determination as to whether or not the inspection target (216) is the first substance. Thus, the accuracy of identification of the inspection target (216) can be improved.

In an inspection system (100; 130) of a second aspect referring to the first aspect, the spectrum corrector (32) is configured to correct, based on a first reference spectrum (321) and a second reference spectrum (322), the first spectrum (315) to generate the second spectrum (317). The first reference spectrum (321) is a spectrum of an image (221) of a second substance (213) in a first reference image (421). The second reference spectrum (322) is a spectrum of an image (222) of the second substance (214) in a second reference image (422). The first reference image (421) is obtained by imaging the second substance (213) at least one of a dimension, a shape, or an arrangement of which is known and which includes a portion having a width less than a threshold. The second reference image (422) is obtained by imaging the second substance (214) at least one of a dimension, a shape, or an arrangement of which is known and which has a width greater than or equal to the threshold.

With the inspection system (100; 130) of the second aspect, a correction of reducing the influence of the spectrum (316) of the background (217) is made based on the first reference spectrum (321) and the second reference spectrum (322) which are two spectra of the same materials having different dimensions. Thus, the influence of the spectrum (316) of the background (217) can be reduced with high accuracy.

In an inspection system (100; 130) of a third aspect referring to the second aspect, the first substance and the second substance are different substances.

With the inspection system (100; 130) of the third aspect, the second substance which is the object for each of the first reference image (421) and the second reference image (422) does not have to be the same as the first substance which may be included in the object for the inspection target image (420). Thus, a correction model does not have to be generated for each first substance, thereby saving labor for generating the correction model.

In an inspection system (100; 130) of a fourth aspect referring to the second or third aspect, the first reference image (421) is an image obtained by imaging a particle of the second substance (213).

The inspection system (100; 130) of the fourth aspect enables the first reference image (421) to be generated by imaging the second substance (213) in the shape of a particle. Thus, the correction model can be easily generated. Moreover, since a spectrum correction model suitable for the object (410) in the shape of a particle is generated, the spectrum can be corrected with high accuracy when the inspection target (216) is in the shape of a particle, thereby improving the accuracy of identification of the inspection target (216).

In an inspection system (100; 130) of a fifth aspect referring to the fourth aspect, the second reference image (422) is an image obtained by imaging a particle of the second substance (214).

The inspection system (100; 130) of the fifth aspect enables the second reference image (422) to be generated by imaging the second substance in the shape of a particle. Thus, the first reference image (421) and the second reference image (422) can be easily prepared by imaging particles, having different sizes, of the second substance.

In an inspection system (100; 130) of a sixth aspect referring to the second or third aspect, the first reference image (421) is an image obtained by imaging a TEG pattern including the second substance (213).

The inspection system (100; 130) of the sixth aspect enables a spectrum correction model suitable for the object (410) which is the TEG pattern to be generated. Thus, when the inspection target (216) is the TEG pattern, the spectrum can be corrected with high accuracy, thereby improving the accuracy of identification of the inspection target (216).

In an inspection system (100; 130) of a seventh aspect referring to the sixth aspect, the second reference image (422) is an image obtained by imaging a TEG pattern including the second substance (214).

The inspection system (100; 130) of the seventh aspect enables the first reference image (421) and the second reference image (422) to be easily prepared by: creating samples of two types of TEG patterns, having different widths, of the second substance; and imaging the samples.

In an inspection system (100; 130) of an eighth aspect referring to any one of the second to seventh aspects, the result output (40) is configured to output at least one of the first reference spectrum (321) or the second reference spectrum (322).

The inspection system (100; 130) of the eighth aspect enables one of, or both, the first reference spectrum (321) and the second reference spectrum (322) to be checked by a user. Thus, whether or not the spectrum correction by the spectrum corrector (32) is appropriate can be checked by the user.

In an inspection system (100; 130) of a ninth aspect referring to any one of the first to eighth aspects, the result output (40) is configured to output the second spectrum (317).

The inspection system (100; 130) of the ninth aspect enables the second spectrum (317) to be checked by the user. Thus, at least one of whether or not the spectrum correction by the spectrum corrector (32) is appropriate or whether or not the determination by the spectrum determiner (33) is appropriate can be checked by the user.

In an inspection system (100; 130) of a tenth aspect referring to any one of the first to ninth aspects, the result output (40) is configured to output the first spectrum (315).

The inspection system (100; 130) of the tenth aspect enables the first spectrum (315) to be checked by the user. Thus, whether or not the spectrum correction by the spectrum corrector (32) is appropriate can be checked by the user.

A model generation system (120) of an eleventh aspect includes a reference image acquirer (11) and a correction model generator (12). The reference image acquirer (11) is configured to acquire a first reference image (421) and a second reference image (422). Each of the first reference image (421) and the second reference image (422) is obtained by imaging a predetermined substance at least one of a dimension, a shape, and an arrangement of which is known and a background (215) in four or more wavelength ranges. The correction model generator (12) is configured to generate a spectrum correction model by using training data based on a first reference spectrum (321) and a second reference spectrum (322). The first reference spectrum (321) is a spectrum of an image (221) of the predetermined substance (213) in the first reference image (421). The second reference spectrum (322) is a spectrum of an image (222) of the predetermined substance (214) in the second reference image (422). The first reference image (421) is obtained by imaging the predetermined substance (213) at least one of a dimension, a shape, or an arrangement of which is known and which includes a portion having a width less than a threshold. The second reference image (422) is obtained by imaging the predetermined substance (214) at least one of a dimension, a shape, or an arrangement of which is known and which has a width greater than or equal to the threshold. The spectrum correction model is a machine learning model for making a correction based on a spectrum (316) of an image (225) of a background (217) to a spectrum (315) of an image (224) of an inspection target (216) in an inspection target image (420). The inspection target image (420) is obtained by imaging an object (410) including the inspection target (216) and the background (217) in the four or more wavelength ranges.

With the model generation system (120) of the eleventh aspect, the correction model is generated based on the first reference spectrum (321) and the second reference spectrum (322) which are two spectra of the same materials having different dimensions. Using this correction model enables the correction of reducing the influence of the spectrum (316) of the image (225) of the background (217) over the spectrum (315) of the image (224) of the inspection target (216).

A determination system (110) of a twelfth aspect includes a correction model acquirer (50), an inspection image acquirer (31), a spectrum corrector (32), a spectrum determiner (33), and a result output (40). The correction model acquirer (50) is configured to acquire a spectrum correction model from the model generation system (120) of the eleventh aspect. The inspection image acquirer (31) is configured to acquire an inspection target image (420) obtained by imaging an object (410) including an inspection target (216) and a background (217) in four or more wavelength ranges. The spectrum corrector (32) is configured to correct a first spectrum (315) by using the spectrum correction model to generate a second spectrum (317), the first spectrum (315) being a spectrum of an image (224) of the inspection target (216) in the inspection target image (420). The spectrum determiner (33) is configured to determine, based on the second spectrum (317), whether or not the inspection target (216) is a first substance. The result output (40) is configured to output a determination result by the spectrum determiner (33).

The determination system (110) of the twelfth aspect enables a reduction in the influence of the spectrum (316) of the image (225) of the background (217) over the accuracy of determination as to whether or not the inspection target (216) is the first substance. Thus, the accuracy of identification of the inspection target (216) can be improved.

An inspection method of a thirteenth aspect includes: acquiring an inspection target image (420); making a correction based on a spectrum (316) of an image (225) of a background (217) to a first spectrum (315) to generate a second spectrum (317), the first spectrum (315) being a spectrum of an image (224) of an inspection target (216) in the inspection target image (420); determining, based on the second spectrum (317), whether or not the inspection target (216) is a predetermined substance; and outputting a determination result. The inspection target image (420) is obtained by imaging an object (410) including the inspection target (216) and the background (217) in four or more wavelength ranges.

The inspection method of the thirteenth aspect enables a reduction in the influence of the spectrum (316) of the image (225) of the background (217) over the accuracy of determination as to whether or not the inspection target (216) is the first substance. Thus, the accuracy of identification of the inspection target (216) can be improved.

A program of a fourteenth aspect is a program configured to cause one or more processors to execute the inspection method of the thirteenth aspect.

With the program of the fourteenth aspect, the one or more processors which execute the program serve as the inspection system (100; 130). Thus, the inspection method executed by the one or more processors enables a reduction in the influence of the spectrum (316) of the image (225) of the background (217) over the accuracy of determination as to whether or not the inspection target (216) is the first substance. Thus, the accuracy of identification of the inspection target (216) can be improved.

A model generation method of a fifteenth aspect includes: acquiring a first reference image (421) and a second reference image (422); and generating a spectrum correction model by using training data based on a first reference spectrum (321) and a second reference spectrum (322). Each of the first reference image (421) and the second reference image (422) is obtained by imaging a predetermined substance at least one of a dimension, a shape, or an arrangement of which is known and a background (215) in four or more wavelength ranges. The first reference spectrum (321) is a spectrum of an image (221) of the predetermined substance (213) in the first reference image (421). The second reference spectrum (322) is a spectrum of an image (222) of the predetermined substance (214) in the second reference image (422). The first reference image (421) is obtained by imaging the predetermined substance (213) at least one of a dimension, a shape, or an arrangement of which is known and which includes a portion having a width less than a threshold. The second reference image (422) is obtained by imaging the predetermined substance (214) at least one of a dimension, a shape, or an arrangement of which is known and which includes a portion having a width greater than or equal to the threshold. The spectrum correction model is a machine learning model for making a correction based on a spectrum (316) of an image (225) of a background (217) to a spectrum (315) of an image (224) of an inspection target (216) in an inspection target image (420). The inspection target image (420) is obtained by imaging an object (410) including the inspection target (216) and the background (217) in four or more wavelength ranges.

With the model generation method of the fifteenth aspect, the correction model is generated based on the first reference spectrum (321) and the second reference spectrum (322) which are two spectra of the same materials having different dimensions. Using this correction model enables the correction of reducing the influence of the spectrum (316) of the image (225) of the background (217) over the spectrum (315) of the image (224) of the inspection target (216).

A program of a sixteenth aspect is a program configured to cause one or more processors to execute the model generation method of the fifteenth aspect.

With the program of the sixteenth aspect, the one or more processors which execute the program function as the model generation system (120). Thus, the model generation method executed by the one or more processors generates the correction model on the basis of the first reference spectrum (321) and the second reference spectrum (322) which are two spectra of the same materials having different dimensions. Using this correction model enables the correction of reducing the influence of the spectrum (316) of the image (225) of the background (217) over the spectrum (315) of the image (224) of the inspection target (216).

### REFERENCE SIGNS LIST

100, 130 Inspection System
110 Determination System
120 Model Generation System
11 Reference Image Acquirer
12 Correction Model Generator
110 Determination System
31 Inspection Image Acquirer
32 Spectrum Corrector
33 Spectrum Determiner
40 Result Output
50 Correction Model Acquirer
213, 214 Second Substance (Predetermined Substance)
216 Inspection Target
215, 217 Background
221, 222 Image of Second Substance
224 Image of Inspection Target
223, 225 Image of Background
315 First Spectrum
316 Spectrum of Image of Background
317 Second Spectrum
321 First Reference Spectrum
322 Second Reference Spectrum
410 Object
420 Inspection Target Image
421 First Reference Image
422 Second Reference Image

1. An inspection system comprising:
an inspection image acquirer configured to acquire an inspection target image obtained by imaging an object including an inspection target and a background in four or more wavelength ranges;
a spectrum corrector configured to make a correction based on a spectrum of an image of the background to a first spectrum to generate a second spectrum, the first spectrum being a spectrum of an image of the inspection target in the inspection target image;
a spectrum determiner configured to determine, based on the second spectrum, whether or not the inspection target is a first substance; and
a result output configured to output a determination result by the spectrum determiner.

2. The inspection system of claim 1, wherein
the spectrum corrector is configured to correct, based on a first reference spectrum and a second reference spectrum, the first spectrum to generate the second spectrum,
the first reference spectrum is a spectrum of an image of a second substance in a first reference image,
the second reference spectrum is a spectrum of an image of the second substance in a second reference image,
the first reference image is obtained by imaging the second substance at least one of a dimension, a shape, or an arrangement of which is known and which includes a portion having a width less than a threshold, and
the second reference image is obtained by imaging the second substance at least one of a dimension, a shape, or an arrangement of which is known and which has a width greater than or equal to the threshold.

3. The inspection system of claim 2, wherein
the first substance and the second substance are different substances.

4. The inspection system of claim 2, wherein
the first reference image is an image obtained by imaging a particle of the second substance.

5. The inspection system of claim 4, wherein
the second reference image is an image obtained by imaging a particle of the second substance.

6. The inspection system of claim 2, wherein
the first reference image is an image obtained by imaging a TEG pattern including the second substance.

7. The inspection system of claim 6, wherein
the second reference image is an image obtained by imaging a TEG pattern including the second substance.

8. The inspection system of claim 2, wherein
the result output is configured to output at least one of the first reference spectrum or the second reference spectrum.

9. The inspection system of claim 1, wherein
the result output is configured to output the second spectrum.

10. The inspection system of claim 1, wherein
the result output is configured to output the first spectrum.

11. A model generation system comprising:
a reference image acquirer configured to acquire a first reference image and a second reference image, each of the first reference image and the second reference image being obtained by imaging a predetermined substance at least one of a dimension, a shape, and an arrangement of which is known and a background in four or more wavelength ranges; and
a correction model generator configured to generate a spectrum correction model by using training data based on a first reference spectrum and a second reference spectrum, the first reference spectrum being a spectrum of an image of the predetermined substance in the first reference image, the second reference spectrum being a spectrum of an image of the predetermined substance in the second reference image,
the first reference image being obtained by imaging the predetermined substance at least one of a dimension, a shape, or an arrangement of which is known and which includes a portion having a width less than a threshold,
the second reference image being obtained by imaging the predetermined substance at least one of a dimension, a shape, or an arrangement of which is known and which has a width greater than or equal to the threshold,
the spectrum correction model being a machine learning model for making a correction based on a spectrum of an image of a background to a spectrum of an image of an inspection target in an inspection target image obtained by imaging an object including the inspection target and the background in the four or more wavelength ranges.

12. A determination system comprising:
a correction model acquirer configured to acquire a spectrum correction model from the model generation system of claim 11;
an inspection image acquirer configured to acquire an inspection target image obtained by imaging an object including an inspection target and a background in four or more wavelength ranges;
a spectrum corrector configured to correct a first spectrum by using the spectrum correction model to generate a second spectrum, the first spectrum being a spectrum of an image of the inspection target in the inspection target image;
a spectrum determiner is configured to determine, based on the second spectrum, whether or not the inspection target is a first substance; and
a result output is configured to output a determination result by the spectrum determiner.

13. An inspection method comprising:
acquiring an inspection target image obtained by imaging an object including an inspection target and a background in four or more wavelength ranges;
making a correction based on a spectrum of an image of the background to a first spectrum to generate a second spectrum, the first spectrum being a spectrum of an image of the inspection target in the inspection target image;
determining, based on the second spectrum, whether or not the inspection target is a predetermined substance; and
outputting a determination result.

14. A non-transitory storage medium storing a program configured to cause one or more processors to execute the inspection method of claim 13.

15. A model generation method comprising:
acquiring a first reference image and a second reference image, each of the first reference image and the second reference image being obtained by imaging a predetermined substance at least one of a dimension, a shape, or an arrangement of which is known and a background in four or more wavelength ranges; and
generating a spectrum correction model by using training data based on a first reference spectrum and a second reference spectrum, the first reference spectrum being a spectrum of an image of the predetermined substance in the first reference image, the second reference spectrum being a spectrum of an image of the predetermined substance in the second reference image,
the first reference image being obtained by imaging the predetermined substance at least one of a dimension, a shape, or an arrangement of which is known and which includes a portion having a width less than a threshold,
the second reference image being obtained by imaging the predetermined substance at least one of a dimension, a shape, or an arrangement of which is known and which includes a portion having a width greater than or equal to the threshold,
the spectrum correction model being a machine learning model for making a correction based on a spectrum of an image of a background to a spectrum of an image of an inspection target in an inspection target image obtained by imaging an object including the inspection target and the background in the four or more wavelength ranges.

16. A non-transitory storage medium storing a program configured to cause one or more processor to execute the model generation method of claim 15.
